(19) United States
(12) Patent Application Publication
(10) Pub. No.: US 2009/0282992 A1
(43) Pub. Date: Nov. 19, 2009

(54) CELEBRATORY STENCIL, CELEBRATORY STENCIL KIT, AND METHOD

(76) Inventor: LINDA D. MULROONEY, FOLSOM, CA (US)

Correspondence Address: James Ray & Associates, 2640 Pitcairn Road, Monroeville, PA, 15146, US

(21) Appl. No.: 12/463,464

(22) Filed: May 11, 2009

Related U.S. Application Data
(60) Provisional application No. 61/053,839, filed on May 16, 2008.

(51) Int. Cl. B05C 17/06

(52) U.S. Cl. 101/127.1

(57) ABSTRACT

A celebratory stencil includes at least one predetermined stencil having a predetermined size and a predetermined shape and including at least one aperture disposed there through. A celebratory stencil kit is also disclosed. Such celebratory stencil kit includes at least one predetermined stencil having a predetermined shape and a predetermined size and including at least one aperture disposed there through and such kit further includes a predetermined amount of at least one of a predetermined powder, a predetermined paint, and a combination thereof for being at least one of dusted, brushed, sprinkled, spread, and a combination thereof within such at least one aperture. A method of using a celebratory stencil kit is also provided.

### CROSS REFERENCE TO RELATED APPLICATION

This patent application is related to and claims priority from U.S. Provisional Patent Application Ser. No. 61/053,839 filed May 16, 2008.

### FIELD OF THE INVENTION

The present invention relates, in general, to stencils and, more particularly, this invention relates to a stencil, a stencil kit, and a method of using a stencil kit.

### BACKGROUND OF THE INVENTION

Prior to the conception and development of the present invention, stencils as are generally well known in the prior art, have been used to provide outlines of predetermined objects and the like for use in painting patterns on walls.

Specifically of interest to the present invention are the following: Colak, U.S. Pat. No. 7,258,592, discloses a kit for creating an illusion that suggests a Santa Claus visit in a premises. The kit includes a displayer at which small items can be placed, amusement items, and means for making boot print resembling marks.

Reese, U.S. Publication No. 2006/0116049, discloses a kit for simulating a visit by Santa Claus which includes a plurality of items to be placed in and/or around a dwelling or other location to enhance the impression and belief that Santa Claus and his reindeer had been present in and around the dwelling. A method of simulating a visit by Santa Claus is also disclosed by Reese.

Clarke, et al, U.S. Publication No. 2002/0128081, discloses an Easter kit and a Christmas kit for entertaining children. A rabbit paw print marking stamp and a reindeer hoof print marking stamp are included.

### SUMMARY OF THE INVENTION

The present invention provides a celebratory stencil which includes at least one predetermined stencil having a predetermined size and a predetermined shape and including at least one aperture disposed there through.

According to another embodiment, a celebratory stencil kit is provided. The celebratory stencil kit includes at least one predetermined stencil having a predetermined shape and a predetermined size and including at least one aperture disposed there through and such kit further including a predetermined amount of at least one of a predetermined powder, a predetermined paint, and a combination thereof for at least one of dusting, brushing, sprinkling, spreading, and a combination thereof within such at least one aperture.

According to still another embodiment, a method of using a celebratory stencil kit includes the steps of: providing a celebratory stencil kit including at least one predetermined stencil having a predetermined shape and a predetermined size and including at least one aperture disposed there through and such kit including a predetermined amount of at least one of a predetermined powder, a predetermined paint, and a combination thereof; placing such at least one predetermined stencil in a predetermined location; and at least one of brushing, dusting, sprinkling, spreading and a combination thereof a second predetermined amount of such at least one of such predetermined powder, such predetermined paint, and such combination thereof within such at least one aperture.

### OBJECTS OF THE INVENTION

It is, therefore, one of the primary objects of the present invention to provide a celebratory stencil which can be used to create footprints specifically associated with a holiday, celebration, event, and the like to further enhance enjoyment of children and adults.

Another object of the present invention is to provide a stencil kit which includes stencils having apertures formed therein such that powder may be used to make footprints of similar shapes and sizes at a predetermined location such that children will believe that a predetermined, person animal, character and the like, such as the Easter Bunny, Santa Claus, an elf, reindeer, leprechauns, a pirate, the Tooth Fairy, Baba Bear, etc. have been at such predetermined location.

Still another object of the present invention is to provide a method of using a stencil kit.

Yet another object of the present invention is to provide a stencil kit which includes at least one footprint stencil, powder and/or paint for use with such at least one footprint stencil, and a brush for brushing, dusting, sprinkling, spreading, and a combination thereof such powder and/or paint at within at least one aperture disposed through such stencil.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention in which such at least one predetermined stencil includes a plurality of apertures formed to resemble a plurality of footprints associated with a plurality of holidays.

FIG. 2 is a partial perspective view of the invention according to one embodiment of the invention; a user is illustrated using such at least one predetermined stencil.

FIG. 3 is a partial perspective view of the invention according to one embodiment of the invention in which such predetermined powder is illustrated in the form of footprints made via use of such at least one predetermined stencil; a pair of small children are depicted in awe of such footprints.

FIG. 4 is a partial perspective view of the invention according to one embodiment of the invention in which such celebratory stencil kit includes a brush.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

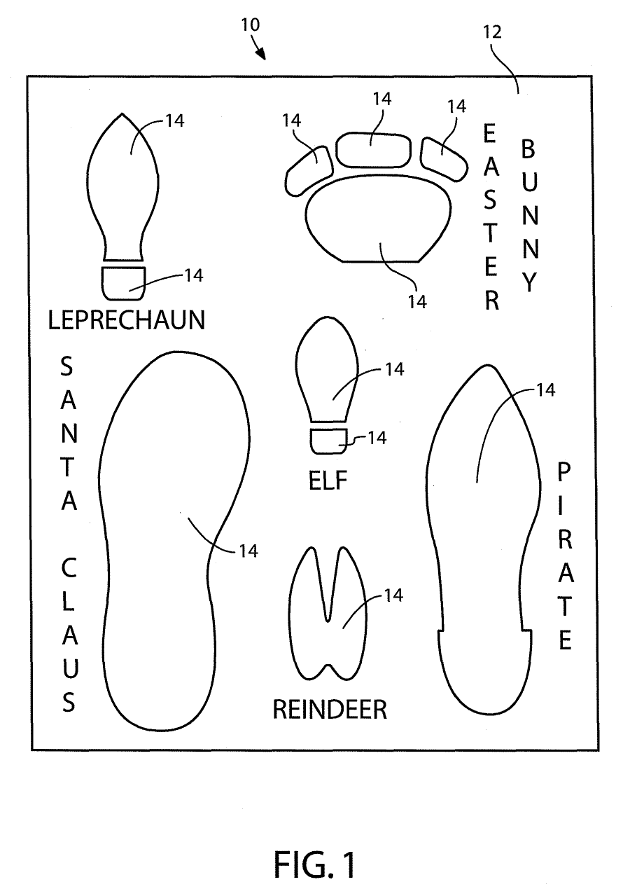

Reference is now made, more particularly, to FIG. 1.

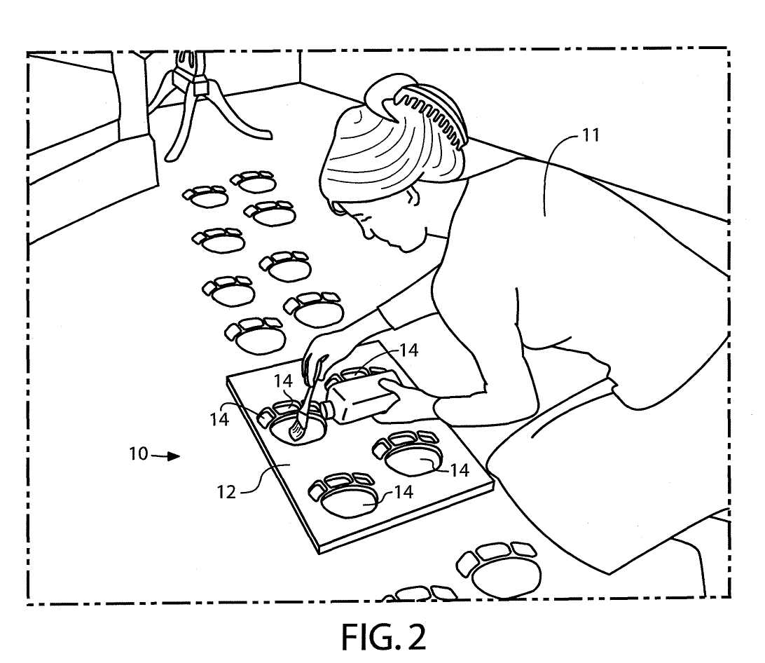

Referring more specifically to FIGS. 1-2, the present invention provides a celebratory stencil, generally designated 10, which includes at least one predetermined stencil 12 having a predetermined size and a predetermined shape and including at least one aperture 14 disposed there through. It is presently preferred that such at least one predetermined stencil 12 includes a plurality of apertures 14 disposed there through, such apertures 14 being formed to resemble footprints of at least one of a predetermined person, a predetermined character, a predetermined animal, and a combination thereof. It is further presently preferred that such at least one predetermined character is at least one of Santa Claus, the Easter Bunny, St. Nicholas, a leprechaun, a pirate, a reindeer, an elf, the Tooth Fairy, Baba Bear, and a combination thereof. It is meant that a user 11 utilize such celebratory stencil 10 in creating predetermined footprints to aid children 15 in believing that such predetermined person, character, animal, and such combination thereof have been at a predetermined location.

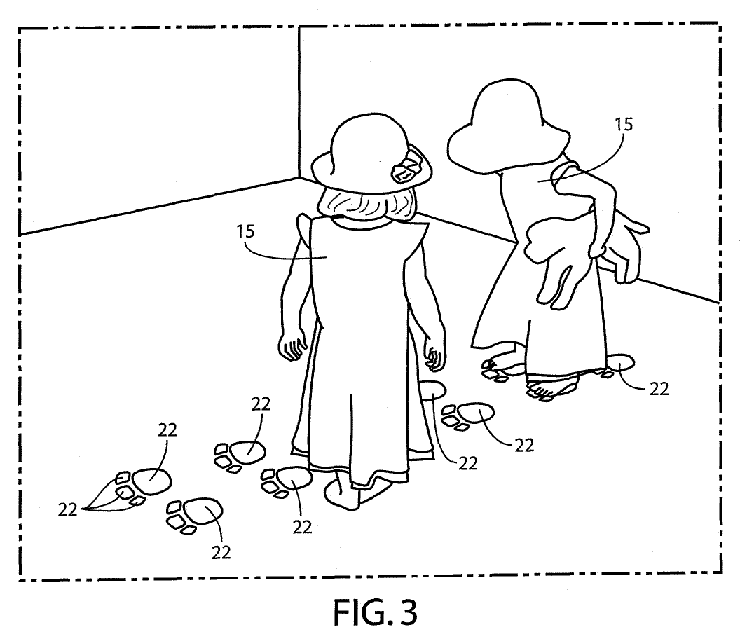

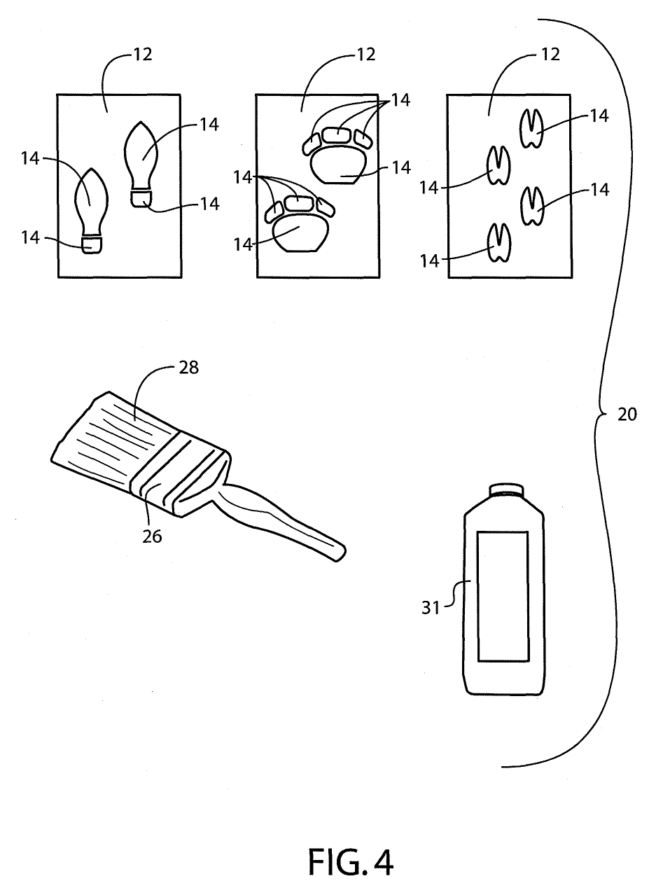

According to another embodiment, referring more specifically to FIGS. 2-4, a celebratory stencil kit, generally designated 20, is provided. Such celebratory stencil kit 20 includes at least one predetermined stencil 12 having a predetermined shape and a predetermined size and including at least one aperture 14 disposed there through and such kit 20 also includes a predetermined amount of at least one of a predetermined powder 22, a predetermined paint 31, and a combination thereof for being at least one of dusted, brushed, sprinkled, spread and a combination thereof within such at least one aperture.

It is presently preferred that such predetermined powder 22 is at least one of chalk dust, baby powder, talcum powder, powdered sugar, baking soda, baking powder, and a combination thereof. It is presently most preferred that such predetermined powder is baby powder.

It is further presently preferred that such kit 20 includes a brush member 26 including a plurality of bristles 28 disposed thereon for use in at least one of dusting, brushing, sprinkling, spreading, and a combination thereof such at least one of such predetermined powder 22, such predetermined paint 31, and a combination thereof within such at least one aperture.

Such at least one aperture 14 is preferably formed as at least one footprint of at least one of a predetermined person, a predetermined animal, a predetermined character, and a combination thereof. It is further presently preferred that such at least one predetermined character is at least one of Santa Claus, the Easter Bunny, St. Nicholas, a leprechaun, a pirate, a reindeer, an elf, the Tooth Fairy, Baba Bear, and a combination thereof.

According to another embodiment such at least one aperture 14 is formed as a pair of footprints of at least one of a predetermined person, a predetermined character, a predetermined animal, and a combination thereof.

Furthermore, such kit may include a plurality of stencils, each of such plurality of stencils including a plurality of apertures disposed there through such that each one of such plurality of stencils includes apertures resembling one of a plurality of predetermined footprints.

It is meant that a user 11 utilize such kit 20 in creating predetermined footprints to aid children 15 in believing that such predetermined person, character, animal, and such combination thereof have been at a predetermined location.

According to still another embodiment, a method of using a celebratory stencil kit includes the steps of providing a celebratory stencil kit including at least one predetermined stencil having a predetermined shape and a predetermined size and including at least one aperture disposed there through and such kit further including a predetermined amount of at least one of a predetermined powder, a predetermined paint, and a combination thereof; placing such at least one predetermined stencil in a predetermined location; and at least one of brushing, dusting, sprinkling, spreading, and a combination thereof a second predetermined amount of such at least one of such predetermined powder, such predetermined paint, and such combination thereof within such at least one aperture.

It is presently preferred that such method further includes the step of providing a brush member including a plurality of bristles disposed thereon for use in at least one of dusting, brushing, sprinkling, spreading, and a combination thereof such second predetermined amount of such at least one of such predetermined powder, such predetermined paint, and such combination thereof within such at least one aperture.

It is further presently preferred that such method includes the step of removing such at least one predetermined stencil from such predetermined location after such second predetermined amount of such at least one of such predetermined powder, such predetermined paint, and such combination thereof has been at least one of dusted, brushed, sprinkled, spread and a combination thereof within such at least one aperture.

It is meant that a user utilize such method in creating predetermined footprints to aid children in believing that such predetermined person, character, animal, and such combination thereof have been at a predetermined location.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A celebratory stencil comprising at least one predetermined stencil having a predetermined size and a predetermined shape and including at least one aperture disposed there through.

2. A celebratory stencil according to claim 1 wherein said at least one predetermined stencil includes a plurality of apertures disposed there through, such apertures being formed to resemble footprints of at least one of a predetermined person, a predetermined character, a predetermined animal, and a combination thereof.

3. A celebratory stencil according to claim 2 wherein said at least one predetermined character is at least one of Santa Claus, the Easter Bunny, St. Nicholas, a leprechaun, a pirate, a reindeer, an elf, the Tooth Fairy, Baba Bear, and a combination thereof.

4. A celebratory stencil kit comprising:
a. at least one predetermined stencil having a predetermined shape and a predetermined size and including at least one aperture disposed there through; and
b. a predetermined amount of at least one of a predetermined powder, a predetermined paint, and a combination thereof for being at least one of dusted, brushed, sprinkled, spread, and a combination thereof within said at least one aperture.

5. A celebratory stencil kit according to claim 4 wherein said predetermined powder is at least one of chalk dust, baby powder, talcum powder, powdered sugar, baking soda, baking powder, and a combination thereof.

6. A celebratory stencil kit according to claim 5 wherein said predetermined powder is baby powder.

7. A celebratory stencil kit according to claim 4 wherein said kit further includes a brush member including a plurality of bristles disposed thereon for use in at least one of dusting, brushing, sprinkling, spreading, and a combination thereof said predetermined amount of said at least one of said predetermined powder, said predetermined paint, and said combination thereof within such at least one aperture.

8. A celebratory stencil kit according to claim 4 wherein said at least one aperture is formed as at least one footprint of at least one of a predetermined person, a predetermined animal, a predetermined character, and a combination thereof.

9. A celebratory stencil kit according to claim 8 wherein said at least one predetermined character is at least one of Santa Claus, the Easter Bunny, St. Nicholas, a leprechaun, a pirate, a reindeer, an elf, the Tooth Fairy, Baba Bear, and a combination thereof.

10. A celebratory stencil kit according to claim 4 wherein said at least one aperture is formed as a pair of footprints of at least one of a predetermined person, a predetermined character, a predetermined animal, and a combination thereof.

11. A celebratory stencil kit according to claim 4 wherein said kit further includes a plurality of stencils, each of said plurality of stencils including a plurality of apertures disposed there through such that each one of said plurality of stencils includes apertures resembling one of a plurality of predetermined footprints.

12. A method of using a celebratory stencil kit comprising the steps of:
a. providing a celebratory stencil kit including;
i. at least one predetermined stencil having a predetermined shape and a predetermined size and including at least one aperture disposed there through;
ii. a predetermined amount of at least one of a predetermined powder, a predetermined paint, and a combination thereof;
b. placing said at least one predetermined stencil in a predetermined location; and
c. at least one of brushing, dusting, sprinkling, spreading and a combination thereof a second predetermined amount of said at least one of said predetermined powder, said predetermined paint, and said combination thereof within said at least one aperture.

13. The method according to claim 12 wherein said method further includes the step of providing a brush member including a plurality of bristles disposed thereon for use in at least one of dusting, brushing, sprinkling, spreading, and a combination thereof said second predetermined amount of said at least one of said predetermined powder, said predetermined paint, and said combination thereof within such at least one aperture.

14. The method according to claim 12 wherein said method further includes the step of removing said at least one predetermined stencil from said predetermined location after said second predetermined amount of said predetermined powder has been at least one of brushed, dusted, sprinkled, spread and a combination thereof within said at least one aperture.
